(19) United States
(12) Patent Application Publication
(10) Pub. No.: US 2025/0016777 A1
(43) Pub. Date: Jan. 9, 2025

(54) CONTROL INFORMATION TRANSMISSION TECHNIQUES

(71) Applicant: ZTE Corporation, Shenzhen (CN)

(72) Inventors: Xiaolong GUO, Shenzhen (CN); Bo GAO, Shenzhen (CN); Ke YAO, Shenzhen (CN); Yang ZHANG, Shenzhen (CN); Zhaohua LU, Shenzhen (CN)

(21) Appl. No.: 18/787,410

(22) Filed: Jul. 29, 2024

Related U.S. Application Data
(63) Continuation of application No. PCT/CN2023/072659, filed on Jan. 17, 2023.

(51) Int. Cl. H04W 72/21; H04L 5/00

(52) U.S. Cl. CPC H04W 72/21; H04L 5/0092

(57) ABSTRACT

Techniques are described for performing control information transmission. An example wireless communication method includes transmitting, by a communication device, control information on a shared channel using one or more transmission layers, where the control information is transmitted on the shared channel using one or more transport blocks or one or more codewords, and where the control information is multiplexed on the shared channel based on a type of the control information.

### CROSS-REFERENCE TO RELATED APPLICATION

This application is a continuation and claims priority to International Application No. PCT/CN2023/072659, filed on Jan. 17, 2023, the disclosure of which is hereby incorporated by reference herein in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

The disclosed technology describes example techniques to transmit a shared channel (e.g., physical uplink shared channel (PUSCH)) with a total number of transport blocks (e.g., two TBs) and transmit control information (e.g., uplink control information (UCI)) on the shared channel with the total number of transport blocks. For example, the disclosed technology can be used to determine layer mapping, modulation and coding scheme, redundant version, etc. for the two transport blocks, and can be used to describe techniques to obtain the coded bits for multiplexed data and control information when the control information is multiplexed onto the shared channel transmission or to determine the transmission of control information on the shared channel without uplink shared channel (UL-SCH). In another example, the disclosed technology can be used to determine a number of coded modulation symbols for control information in a layer of the shared channel.

An example wireless communication method includes transmitting, by a communication device, control information on a shared channel using one or more transmission layers, where the control information is transmitted on the shared channel using one or more transport blocks or one or more codewords, and where the control information is multiplexed on the shared channel based on a type of the control information.

In some embodiments, a number of transport blocks or a number of codewords is based on at least one of: a total number of the one or more transmission layers, or a first message received from a network device. In some embodiments, the first message indicates to enable or allow an uplink transmission with more than one codeword or more than one transport block. In some embodiments, the first message indicates a maximum number of codewords or a maximum number of transport blocks for an uplink transmission is one or more. In some embodiments, an uplink transmission is associated with the shared channel.

In some embodiments, a payload of an indication field for a second transport block is zero in a downlink control information (DCI) corresponding to an uplink transmission in response to: determining an absence of a reception of a first message, receiving the first message that indicates that an uplink transmission with two codewords is disabled, or a configured maximum number of transmission layers or rank of the uplink transmission being not greater than a specific value. In some embodiments, the control information is multiplexed on one transport block or on two transport blocks for all types of the control information. In some embodiments, the control information is multiplexed on one transport block or on two transport blocks based on the type of the control information. In some embodiments, the control information is multiplexed on one or two transport blocks based on a bit size of the control information or a bit size of coded bits for the control information.

In some embodiments, the control information is multiplexed on the shared channel by determining one or two sets of coded bits for control information to be transmitted on the shared channel, wherein the one or two sets of coded bits are determined according to any one of: generating one set of coded bits for the control information based on bits of the control information; or dividing bits of the control information into two parts, and generating two sets of coded bits corresponding to the two parts; or generating one set of coded bits for the control information based on the bits of the control information, and dividing the one set of coded bits for the control information into two sets; or generating one set of coded bits for the control information based on the bits of the control information, and obtaining two sets of coded bits by replicating the one set of coded bits; or generating a first set of coded bits for the control information based on the bits of the control information, and generating a second set of coded bits for the information based on the bits of the control information. In some embodiments, the determining of the one or two sets of coded bits for control information is based on the type of the control information, a bit size of the control information, or a bit size of the coded bits of the control information.

In some embodiments, the control information is multiplexed on the shared channel according to the following: a first set of coded bits for the control information and a second set of coded bits for the control information is multiplexed with coded bits for a first uplink shared channel (UL-SCH) transport block and a second UL-SCH transport block, respectively. In some embodiments, the control information is multiplexed on the shared channel according to the following: a first set of coded bits for the control information and a second set of coded bits for the control information are transmitted on a first transport block and a second transport block of a physical uplink shared channel (PUSCH) in response to an uplink shared channel (UL-SCH) being not present in the PUSCH. In some embodiments, the control information is multiplexed on the shared channel by determining a number of coded modulation symbols for the control information in a transmission layer of a transport block onto which the control information is multiplexed.

In some embodiments, the number of coded modulation symbols is determined to be one of the following or a minimum number of more than one of the following: a value based on a scaling factor, and a total number of resource elements or a total number of subcarriers to be used for the transmitting the control information in all or specific orthogonal frequency division multiplex (OFDM) symbols; a number of coded modulation symbols for the control information with a different type in the transmission layer; a value based on a number of bits of the control information, a number of a cyclic redundancy check (CRC) bits for the control information, an offset value, a sum of code block size for a corresponding or both uplink shared channel (UL-SCH) transport block of the shared channel transmission and a total number of resource elements or a total number of subcarriers to be used for the transmitting the control information in all OFDM symbols of a corresponding transport block or both transport blocks; a value based on the number of bits of the control information, the number of CRC bits for the control information, the offset value, a code rate of each of two transport blocks of the shared channel and a modulation order of each of the two transport blocks of the shared channel; or a value based on the number of bits of the control information, the number of CRC bits for the control information, the offset value, the code rate of the corresponding transport block of the shared channel and the modulation order of the corresponding transport block of the shared channel.

In some embodiments, the control information includes hybrid automatic repeat request acknowledgement (HARQ-ACK) information, scheduling request (SR), link recovery request (LRR), channel state information (CSI) part 1, or CSI part 2. In some embodiments, the control information includes uplink control information (UCI), and wherein the shared channel includes a physical uplink shared channel (PUSCH).

Another example wireless communication method includes receiving, by a network device, control information on a shared channel on one or more transmission layers from a communication device, where the control information is received on the shared channel using one or more transport blocks or one or more codewords, and where the control information is multiplexed on the shared channel based a type of the control information.

In some embodiments, a number of transport blocks or a number of codewords is based on at least one of: a total number of the one or more transmission layers, or a first message transmitted by the network device. In some embodiments, the first message indicates to enable or allow an uplink transmission with more than one codeword or more than one transport block, or the first message indicates a maximum number of codewords or a maximum number of transport blocks for an uplink transmission is one or more. In some embodiments, an uplink transmission is associated with the shared channel.

In some embodiments, a payload of an indication field for a second transport block is zero in a downlink control information (DCI) corresponding to an uplink transmission in response to: an absence of a transmission of a first message, transmitting the first message that indicates that the uplink transmission with two codewords is disabled, or a configured maximum number of transmission layers or rank of the uplink transmission being not greater than a specific value. In some embodiments, the control information is multiplexed on one transport block or on two transport blocks for all types of the control information, or where the control information is multiplexed on one transport block or on two transport blocks based on the type of the control information, or where the control information is multiplexed on one or two transport blocks based on a bit size of the control information or a bit size of coded bits for the control information.

In some embodiments, a payload of an indication field in a downlink control information (DCI) for a second transport block in a DCI format is determined by a predefined table and/or a maximum number of schedulable shared channel in response to: a transmission of a first message that indicates to allow or enable an uplink transmission with more than one codeword or more than one transport block, or a maximum number of transmission layers or rank for the uplink transmission is configured to be larger than a specific value. In some embodiments, the control information includes hybrid automatic repeat request acknowledgement (HARQ-ACK) information, scheduling request (SR), link recovery request (LRR), channel state information (CSI) part 1, or CSI part 2. In some embodiments, the control information includes uplink control information (UCI), and wherein the shared channel includes a physical uplink shared channel (PUSCH).

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 illustrates an example of an uplink control information (UCI) multiplexing on physical uplink shared channel (PUSCH) with two transport blocks.

FIGS. 2A-2D show example techniques to obtain at least two transport blocks from control information.

FIG. 3 shows an exemplary flowchart for transmitting control information.

FIG. 4 shows an exemplary flowchart for receiving control information.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

In new radio (NR) systems, when the number of transmission layers is larger than four and two codewords are transmitted on the physical uplink shared channel (PUSCH), the user equipment (UE) may be required to determine the mapping of codeword to layer, modulation and coding scheme, redundant version and transport block size of each of the two transport blocks. For a dynamical or dynamic scheduling PUSCH or a configured grant Type 2 PUSCH, indication fields in the DCI format may be required to be specified. For a configured grant Type 1 PUSCH, information elements in the configuration of configured grant PUSCH may be required to be specified.

When uplink control information (UCI) is multiplexed on the PUSCH with two transport blocks, to multiplex UCI on one or both of the transport blocks requires to be specified firstly, e.g., UCI may be multiplexed on one or both transport blocks, or UCI may be multiplexed on one or both transport blocks based on some rules. Furthermore, methods to obtain the multiplexed data and control bit sequence, and determination of the number of coded modulation symbols in each layer can be significant aspects for UCI multiplexing on PUSCH.

In LTE systems, up to two codewords can be transmitted on the physical uplink shared channel. One codeword can be mapped to 1, 2 or 4 layers. Each codeword correspond to one transport block. In case UCI is multiplexed on PUSCH transmission with two transport blocks, UE determines to multiplex UCI on one or both transport blocks based on the UCI type.

In NR systems, up to two codewords can be transmitted on the physical downlink shared channel but only single codeword can be transmitted on the physical uplink shared channel. One codeword can be mapped to up to four layers of the PUSCH. In case UCI is multiplexed on PUSCH transmission, UCI bits are multiplexed on all layers of the PUSCH.

For the transmission of PUSCH, UE requires to read the modulation and coding scheme filed, redundant version field, or mcsAndTBS to determine the modulation order, target code rate, redundant version and transport block size for the PUSCH. Transport block CRC attachment, code block segmentation, channel coding and rate matching can be applied to the PUSCH.

The UCI may comprise HARQ-ACK information, SR, LRR, and CSI. UCI can be carried on physical uplink control channel (PUCCH) and different PUCCH carrying different UCI type can exist within the same slot or even the same OFDM symbol. In case multiple resources for PUCCH transmission overlap in time domain, UE can determine to multiplex the UCI in a PUCCH resource or determines to drop some UCI based on the predefined rules and/or network configuration.

In case PUCCH resources carrying UCI overlap with PUSCH transmission, either due to transmission of an uplink shared channel (UL-SCH) transport block or due to triggering of aperiodic CSI (A-CSI) transmission without UL-SCH transport block, all or partial UCI bits can be multiplexed in the PUSCH:
UCI carrying HARQ-ACK feedback with 1 or 2 bits is multiplexed by puncturing PUSCH;
In all other cases UCI is multiplexed by rate matching PUSCH.

When UCI bits are multiplexed in the PUSCH, code block segmentation, cyclic redundancy check (CRC) attachment, channel coding and rate matching are also applied for the UCI bits. Coded bits for UCI and coded bits for UL-SCH are multiplexed to generate the multiplexed data and control bit sequence. The multiplexed data and control bit sequence is obtained based on the coded bits for UCI and coded bits for UL-SCH, and it is obtained in the rule of per UCI type, per hopping if configured, per symbol, per resource element (RE), and per layer.

### II. Example Embodiments

In this patent document, PUSCH transmission with more than one codeword can be equivalent to PUSCH transmission with more than one transport block. In this patent document, “control information” can be equivalent to Uplink Control Information (UCI), and may comprise HARQ-ACK information, scheduling request (SR), link recovery request (LRR), channel state information (CSI). CSI can be comprised of CSI part 1 and CSI part 2. In this patent document, uplink transmission can be equivalent to PUSCH transmission, and uplink transmission can be a transmission occasion of PUSCH or a repetition of PUSCH. PUSCH transmission can be PUSCH transmission with dynamic scheduling. configured grant Type 1 or Type 2 PUSCH transmission, PUSCH transmission with repetition type A or Type B.

This patent document describes example techniques to transmit shared channel (e.g., PUSCH) using, for example, two transport blocks and to transmit control information (e.g., UCI) on shared channel (e.g., PUSCH) are considered in the following example aspects:

### II. (a) Example Aspect (1)

UE is scheduled or activated or configured to transmit a physical uplink shared channel (PUSCH) with one or more transmission layers;
UE generates at least one type of uplink control information, which comprising HARQ-ACK information, SR, LRR, CSI part 1 or CSI part 2;
UE determines to transmit or multiplex the at least one uplink control information on the PUSCH.
UE transmits the PUSCH carrying the uplink control information.

The transmission of the PUSCH further comprising UE determining the number of one or more transport blocks or the number of one or more codewords of the PUSCH.
The determining of the number of one or more transport blocks or the number of one or more codewords of the PUSCH is based on the number of transmission layers of the PUSCH.
The determining of the number of one or more transport blocks or the number of one or more codewords of the PUSCH is based on the number of transmission layers and a network message.
   The network message indicates to enable or allow uplink transmission with two codewords or transport blocks.
   The network message indicates the maximum number of codewords or transport blocks of PUSCH is one or two.
   The network message can be configured in the configuration of PUSCH transmission for a BWP, or in the configuration of PUSCH transmission for a cell, or in the configuration of uplink transmission without dynamic grant.

The transmission of the PUSCH further comprising UE determining the modulation order, target code rate, redundant version and transport block size of each of the transport blocks.
The determining is based on the indication fields in the DCI format scheduling or activating the PUSCH transmission or the information elements in the configuration of configured grant PUSCH transmission for each of the transport blocks.
The payload of an indication field for the first transport block is determined by a predefined table and/or the maximum number of schedulable PUSCH.
The payload of an indication field for the second transport block is zero or the information element in the RRC message for the second transport block is absent in the configuration of configured grant PUSCH transmission if: (1) the network message is not configured; or (2) the network message indicates to disable uplink transmission with two codewords; or (3) if the configured maximum number of layers or rank of the uplink transmission is not greater than a specific value, e.g., 4.
The payload of an indication field for the second transport block in DCI format is determined by a predefined table and/or the maximum number of schedulable PUSCH if the network message indicates to allow or enable uplink transmission with two codewords/transport blocks, or if the maximum number of layers or ranks for the uplink transmission is configured to be larger than a specific value (e.g., 4).

More details of Example Aspect (1) can be found in Example Embodiment 1 of this patent document.

### II. (b) Example Aspect (2)

The transmission/multiplexing of the at least one uplink control information on the PUSCH further comprising determining to multiplex uplink control information bits in one or both of the transport blocks.
UE determines to multiplex uplink control information on one of the transport blocks.
UE determines to multiplex uplink control information on both transport blocks.
UE determines to multiplex uplink control information on one or both of the transport blocks based on
   (1) the UCI type.
   (2) the size of bits for uplink control information or the size of coded bits for uplink control information.
   (3) whether UL-SCH is present in the PUSCH or not.
The one of the transport blocks which is determined to multiplex with control information can be the first transport block, the second transport block, or the transport block corresponding to the highest modulation and coding scheme value.

The transmission/multiplexing of the at least one uplink control information on the PUSCH further comprising obtaining coded bits of the uplink control information to be transmitted on the PUSCH for a UCI type.
Uplink control information bits for a UCI type are divided into two parts, and two sets of coded bits for uplink control information are generated.
One set of coded bits for uplink control information is generated based on the uplink control information bits. The set of coded bits for uplink control information is divided into two sets.
One set of coded bits for uplink control information is generated based on the uplink control information bits.
The one or two sets of coded bits for uplink control information are obtained based on the replicating the uplink control information NL times, where NL can be the number of layers onto which the corresponding transport block is mapped.
The one or two sets of coded bits for uplink control information are obtained based on at least one of: interleaving, polar encoding or a coding scheme based on a predefined table/rule.

The transmission/multiplexing of the at least one uplink control information on both of the transport blocks of the PUSCH further comprising performing multiplexing of the coded bits for UL-SCH and uplink control information and obtaining the coded bits for multiplexed data and control information or determining the coded bits for uplink control information to be transmitted on the transport blocks.
The coded bits for multiplexed data and control information of the first and second transport block are obtained based on the first and second set of coded bits for uplink control information and coded bits for the first and second UL-SCH transport blocks.
The coded bits for multiplexed data and control information of the first and second transport block are obtained based on the one set of coded bits for uplink control information and coded bits for the first and second UL-SCH transport blocks.
The first and second set of coded bits for uplink control information are carried on the first and second transport blocks of the PUSCH if UL-SCH is not present in the PUSCH.
The one set of coded bits for uplink control information are carried on the first and second transport blocks of the PUSCH if UL-SCH is not present in the PUSCH.

More details of Example Aspect (2) can be found in Example Embodiment 2 of this patent document.

### II. (c) Example Aspect (3)

The transmission/multiplexing of the at least one uplink control information on the PUSCH further comprising determining the number of coded modulation symbols for uplink control information in a layer of a transport block onto which the uplink control information is multiplexed.
The number of coded modulation symbols for UCI transmission in a layer is determined to be the minimum number of at least one of the following:
   (1) a value determined based on a scaling factor, and the total number of resource elements/subcarriers that can be used for transmission of UCI in all or specific OFDM symbols;
   (2) the number of coded modulation symbols for UCI with a different type in the layer;
   (3) a value determined based on the number of UCI bits, the number of CRC bits for the UCI, an offset value, the sum of code block size for the corresponding or both UL-SCH transport block of the PUSCH transmission and the total number of resource elements/subcarriers that can be used for transmission of UCI in all OFDM symbols of the corresponding or both transport block(s).
   (4) a value determined based on the number of UCI bits, the number of CRC bits for the UCI, an offset value, the code rate of each of the two transport blocks of the PUSCH and the modulation order of each of the two transport blocks of the PUSCH.
   (5) a value determined based on the number of UCI bits, the number of CRC bits for the UCI, an offset value, the code rate of the corresponding transport block of the PUSCH and the modulation order of the corresponding transport block of the PUSCH.
   The specific OFDM symbols which can be used for transmission of UCI are determined based on the DMRS transmission position on the PUSCH.
   The number of UCI bits can be the number of bits for uplink control information or the number of coded bits for uplink control information multiplexed on the PUSCH or on a transport block of the PUSCH or on a layer of the PUSCH.

More details of Example Aspect (3) can be found in Example Embodiment 3 of this patent document.

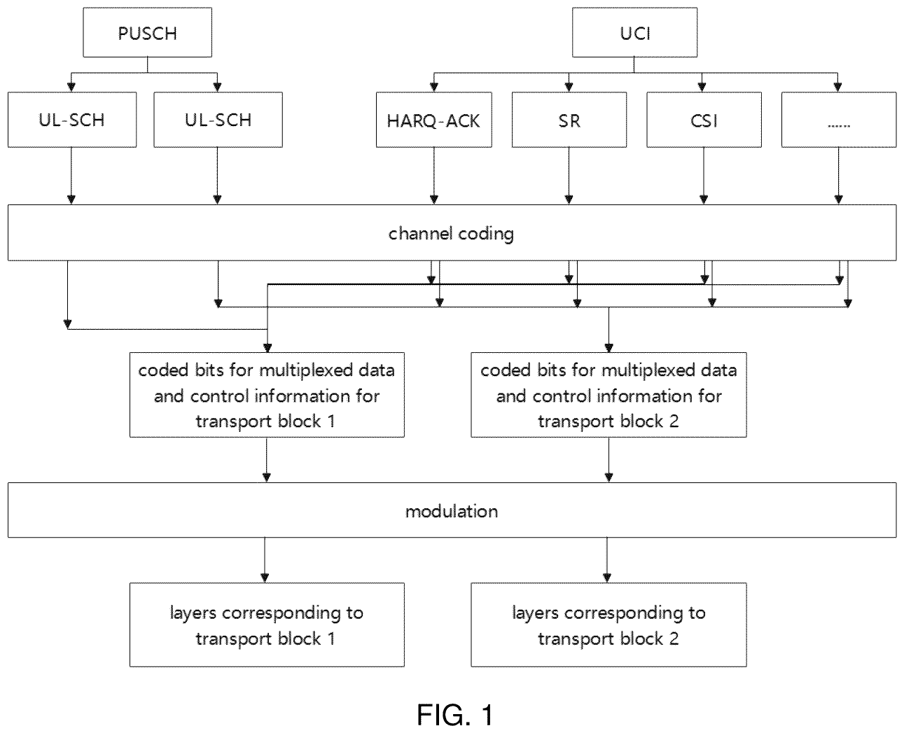

FIG. 1 illustrates an example of uplink control information multiplexing on PUSCH with two transport blocks. Channel coding of each UCI type is performed independently. For each UCI type, two sets of coded bits are obtained, and are multiplexed with coded bits for first and second UL-SCH respectively. After channel coding and modulation, the coded modulation symbols are mapped on the resource elements of layers of the corresponding transport block.

### III. (a) Example Embodiment 1

Example Embodiment 1 describes techniques to transmit PUSCH with more than one transport blocks. UE is configured or scheduled to transmit PUSCH with multiple layers, and UE determines the number of transport blocks based on at least one of the number of transmission layers or a network message. In the following example embodiments, the number of transport blocks is two.

Each of the two codewords is mapped to the corresponding transport block.

In some embodiments, UE determines the mapping of codeword to layer based on the number of layers of the PUSCH transmission. In an example, the mapping of codeword to layer can be as follows. Complex-valued modulation symbols d^{(q)}(0), . . . , d^{(q)}(M_{symb}^{(q)}−1) for codeword q may be mapped onto the layers x(i)=[x⁽⁰⁾(i) . . . x^{v-1)}(i)]^{T}, i=0,1, . . . ,M_{symb}^{layer}−1, where v is the number of layers and M_{symb}^{layer} is the number of modulation symbols per layer.

TABLE 1
Codeword-to-layer mapping for spatial multiplexing

| Number | Number of | Codeword-to-layer mapping | |
|---|---|---|---|
| of layers | codewords | i = 0, 1, . . . , M_{symb}^{layer} − 1 | |
| 1 | 1 | x⁽⁰⁾ (i) = d⁽⁰⁾ (i) | M_{symb}^{layer} = M_{symb}⁽⁰⁾ |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 3 | 1 | x⁽⁰⁾ (i) = d⁽⁰⁾ (3i) | M_{symb}^{layer} = M_{symb}⁽⁰⁾/3 |
| | | x⁽¹⁾ (i) = d⁽⁰⁾ (3i + 1) | |
| | | x⁽²⁾ (i) = d⁽⁰⁾ (3i + 2) | |
| 4 | 1 | x⁽⁰⁾ (i) = d⁽⁰⁾ (4i) | M_{symb}^{layer} = M_{symb}⁽⁰⁾/4 |
| | | x⁽¹⁾ (i) = d⁽⁰⁾ (4i + 1) | |
| | | x⁽²⁾ (i) = d⁽⁰⁾ (4i + 2) | |
| | | x⁽³⁾ (i) = d⁽⁰⁾ (4i + 3) | |
| 5 | 2 | x⁽⁰⁾ (i) = d⁽⁰⁾ (2i) | M_{symb}^{layer} = M_{symb}⁽⁰⁾/2 = |
| | | x⁽¹⁾ (i) = d⁽⁰⁾ (2i + 1) | M_{symb}⁽¹⁾/3 |
| | | x⁽²⁾ (i) = d⁽¹⁾ (3i) | |
| | | x⁽³⁾ (i) = d⁽¹⁾ (3i + 1) | |
| | | x⁽³⁾ (i) = d⁽¹⁾ (3i + 2) | |
| 6 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/3 |
| | | x⁽²⁾ (i) = d⁽⁰⁾ (3i + 2) | |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/4 |
| | | x⁽²⁾ (i) = d⁽⁰⁾ (3i + 2) | |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 3) | |
| 8 | 2 | x⁽⁰⁾ (i) = d⁽⁰⁾ (4i) | M_{symb}^{layer} = M_{symb}⁽⁰⁾/4 = |
| | | x⁽¹⁾ (i) = d⁽⁰⁾ (4i + 1) | M_{symb}⁽¹⁾/4 |
| | | x⁽²⁾ (i) = d⁽⁰⁾ (4i + 2) | |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

In some embodiments, UE determines the mapping of codeword to layer based on the number of layers of the PUSCH transmission and a two-CW-transmission related message from network.

For instance, the two-CW-transmission related message can be twoCodewordUplinkTransmission, morethanfourlayertransmission, enableTwoCodewordTransmission in the configuration of PUSCH transmission with or without dynamic grant. For example, the two-CW-transmission related message is configured in ConfiguredGrantConfig for configured grant PUSCH, and/or it is configured in PUSCHConfig.

In some embodiments, UE receives the message indicative of disabling uplink transmission with two codewords. UE determines the mapping of codeword to layer based on the entries of which the number of codewords is 1 for all the number of layers.

In some embodiments, UE receives the message indicative of enabling uplink transmission with two codewords or does not receive the message indicative of disabling uplink transmission with two codewords. UE determines the mapping of codeword to layer based on the entries of which the number of codewords is 2 when the number of layers is larger than 4.

In an example, the mapping of codeword to layer is as follows. Complex-valued modulation symbols d^{(q)}(0), . . . , d^{(q)}(M_{symb}^{(q)}−1) for codeword q may be mapped onto the layers x(i)=[x⁽⁰⁾(i) . . . x^{(v-1)}(i)]^{T},i=0,1, . . . ,M_{symb}^{layer}−1, where v is the number of layers and M_{symb}^{layer} is the number of modulation symbols per layer.

TABLE 2
Codeword-to-layer mapping for spatial multiplexing.

| Number | Number of | Codeword-to-layer mapping | |
|---|---|---|---|
| of layers | codewords | i = 0, 1, . . . , M_{symb}^{layer} − 1 | |
| 1 | 1 | x⁽⁰⁾ (i) = d⁽⁰⁾ (i) | M_{symb}^{layer} = M_{symb}⁽⁰⁾ |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 3 | 1 | x⁽⁰⁾ (i) = d⁽⁰⁾ (3i) | M_{symb}^{layer} = M_{symb}⁽⁰⁾/3 |
| | | x⁽¹⁾ (i) = d⁽⁰⁾ (3i + 1) | |
| | | x⁽²⁾ (i) = d⁽⁰⁾ (3i + 2) | |
| 4 | 1 | x⁽⁰⁾ (i) = d⁽⁰⁾ (4i) | M_{symb}^{layer} = M_{symb}⁽⁰⁾/4 |
| | | x⁽¹⁾ (i) = d⁽⁰⁾ (4i + 1) | |
| | | x⁽²⁾ (i) = d⁽⁰⁾ (4i + 2) | |
| | | x⁽³⁾ (i) = d⁽⁰⁾ (4i + 3) | |
| 5 | 1 | x⁽⁰⁾ (i) = d⁽⁰⁾ (5i) | M_{symb}^{layer} = M_{symb}⁽⁰⁾/5 |
| | | x⁽¹⁾ (i) = d⁽⁰⁾ (5i + 1) | |
| | | x⁽²⁾ (i) = d⁽⁰⁾ (5i + 2) | |
| | | x⁽³⁾ (i) = d⁽⁰⁾ (5i + 3) | |
| | | x⁽⁴⁾ (i) = d⁽⁰⁾ (5i + 4) | |
| 5 | 2 | x⁽⁰⁾ (i) = d⁽⁰⁾ (2i) | M_{symb}^{layer} = M_{symb}⁽⁰⁾/2 = |
| | | x⁽¹⁾ (i) = d⁽⁰⁾ (2i + 1) | M_{symb}⁽¹⁾/3 |
| | | x⁽²⁾ (i) = d⁽¹⁾ (3i) | |
| | | x⁽³⁾ (i) = d⁽¹⁾ (3i + 1) | |
| | | x⁽³⁾ (i) = d⁽¹⁾ (3i + 2) | |
| 6 | 1 | x⁽⁰⁾ (i) = d⁽⁰⁾ (6i) | M_{symb}^{layer} = M_{symb}⁽⁰⁾/6 |
| | | x⁽¹⁾ (i) = d⁽⁰⁾ (6i + 1) | |
| | | x⁽²⁾ (i) = d⁽⁰⁾ (6i + 2) | |
| | | x⁽³⁾ (i) = d⁽⁰⁾ (6i + 3) | |
| | | x⁽⁴⁾ (i) = d⁽⁰⁾ (6i + 4) | |
| | | x⁽⁵⁾ (i) = d⁽⁰⁾ (6i + 5) | |
| 6 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/3 |
| | | x⁽²⁾ (i) = d⁽⁰⁾ (3i + 2) | |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 1 | x⁽⁰⁾ (i) = d⁽⁰⁾ (7i) | M_{symb}^{layer} = M_{symb}⁽⁰⁾/7 |
| | | x⁽¹⁾ (i) = d⁽⁰⁾ (7i + 1) | |
| | | x⁽²⁾ (i) = d⁽⁰⁾ (7i + 2) | |
| | | x⁽³⁾ (i) = d⁽⁰⁾ (7i + 3) | |
| | | x⁽⁴⁾ (i) = d⁽⁰⁾ (7i + 4) | |
| | | x⁽⁵⁾ (i) = d⁽⁰⁾ (7i + 5) | |
| | | x⁽⁶⁾ (i) = d⁽⁰⁾ (7i + 6) | |
| 7 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/4 |
| | | x⁽²⁾ (i) = d⁽⁰⁾ (3i + 2) | |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 3) | |
| 8 | 1 | x⁽⁰⁾ (i) = d⁽⁰⁾ (8i) | M_{symb}^{layer} = M_{symb}⁽⁰⁾/8 |
| | | x⁽¹⁾ (i) = d⁽⁰⁾ (8i + 1) | |
| | | x⁽²⁾ (i) = d⁽⁰⁾ (8i + 2) | |
| | | x⁽³⁾ (i) = d⁽⁰⁾ (8i + 3) | |
| | | x⁽⁴⁾ (i) = d⁽⁰⁾ (8i + 4) | |
| | | x⁽⁵⁾ (i) = d⁽⁰⁾ (8i + 5) | |
| | | x⁽⁶⁾ (i) = d⁽⁰⁾ (8i + 6) | |
| | | x⁽⁷⁾ (i) = d⁽⁰⁾ (8i + 7) | |
| 8 | 2 | x⁽⁰⁾ (i) = d⁽⁰⁾ (4i) | M_{symb}^{layer} = M_{symb}⁽⁰⁾/4 = |
| | | x⁽¹⁾ (i) = d⁽⁰⁾ (4i + 1) | M_{symb}⁽¹⁾/4 |
| | | x⁽²⁾ (i) = d⁽⁰⁾ (4i + 2) | |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

In some embodiments, UE determines the modulation order, target code rate, redundant version and transport block size of each of the transport blocks based on the at least one indication field of the corresponding transport block in the DCI scheduling PUSCH or activating a configured grant PUSCH, or based on the at least one configuration information provided by RRC signaling for a configured grant PUSCH.

In some embodiments, UE determines the transport block size of each of the transport blocks based on the number of symbols of the PUSCH allocation, the number of REs for DM-RS for the corresponding transport block, or configuration information provided by RRC signaling.

In some embodiments, at least one of the modulation and coding scheme field, redundant version filed, new data indicator field, or CBG transmission information field for transport block 1 and transport block 2 are included in the DCI format scheduling PUSCH or activating configured grant PUSCH.

In some embodiments, if the two-CW-transmission related message is not configured or indicates to disable uplink transmission with two codewords or not indicate to enable uplink transmission with two codewords, or if the configured maximum number of layers or ranks of the uplink transmission is not greater than a specific value, e.g., 4, payload of the modulation and coding scheme field, redundant version filed and new data indicator field, or CBG transmission information field for transport block 2 is 0 bit.

In some embodiments, if the two-CW-transmission related message is configured and indicates to enable uplink transmission with two codewords, or if the maximum number of layers or ranks of the uplink transmission is greater than a specific value, the payload of the modulation and coding scheme field, redundant version filed and new data indicator field for each transport block are determined based on the at least one of: a predefined table, or the maximum number of schedulable PUSCHs among all entries in the PUSCH TDRA list configuration.

In some embodiments, mcsAndTBS and mcsAndTBS2 are configured for transport block 1 and transport block 2 respectively in the configuration of configured grant PUSCH, e.g., ConfiguredGrantConfig.

In some embodiments, repK-RV is configured for both transport block 1 and transport block 2 in the configuration of configured grant PUSCH.

In some embodiments, repK-RV and repK-RV2 are configured for transport block 1 and transport block 2 respectively in the configuration of configured grant PUSCH.

In some embodiments, information elements for the transport block 2, e.g., mcsAndTBS2 and repK-RV2, are absent if the two-CW-transmission related message is not configured or indicates to disable uplink transmission with two codewords or not indicate to enable uplink transmission with two codewords, or if the configured maximum number of layers or ranks of the uplink transmission is not greater than a specific value, e.g., 4.

The number of transport blocks of a PUSCH transmission is one or two according to the number of codewords of the PUSCH transmission. For single codeword, one transport block is transmitted. For two codewords, two transport blocks are transmitted.

### III. (b) Example Embodiment 2

Embodiment 2 describes techniques to obtain the coded bits for multiplexed data and control information when UCI is multiplexed onto the PUSCH transmission or to determine the transmission of uplink control information on PUSCH without UL-SCH.

UE determines to multiplex UCI onto PUSCH when PUCCH carrying UCI overlaps with the PUSCH. UE determines to multiplex all or partial UCI bits on PUSCH based on the priority of UCI, the payload of UCI and the available resource elements for UCI.

### III. (b) (1) Example Aspect 1

Data and control multiplexing is to obtain the multiplexed data and control coded bit sequence based on the coded bits for UL-SCH and coded bits for UCI. Coded bits for different types of UCI are obtained independently.

### A. Data and Control Multiplexing for Both Transport Blocks

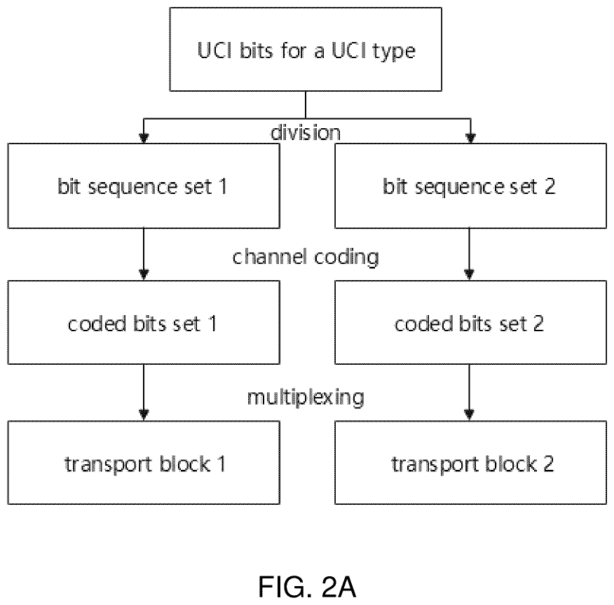

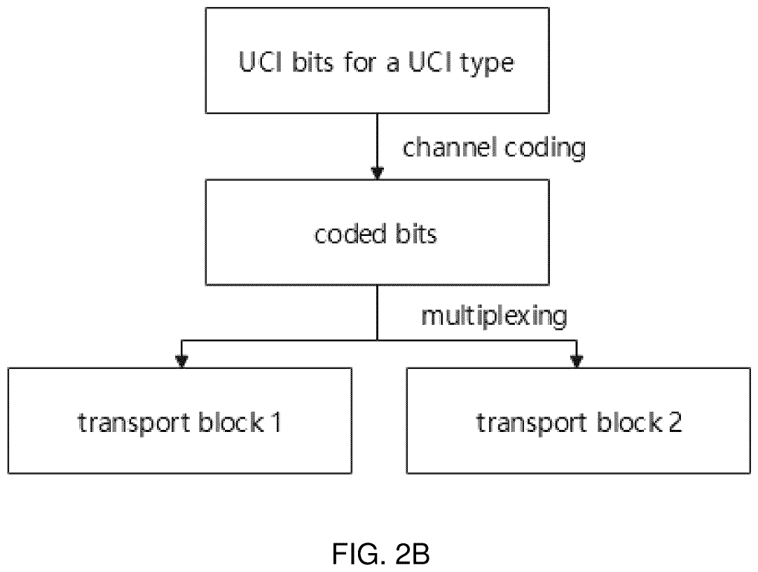

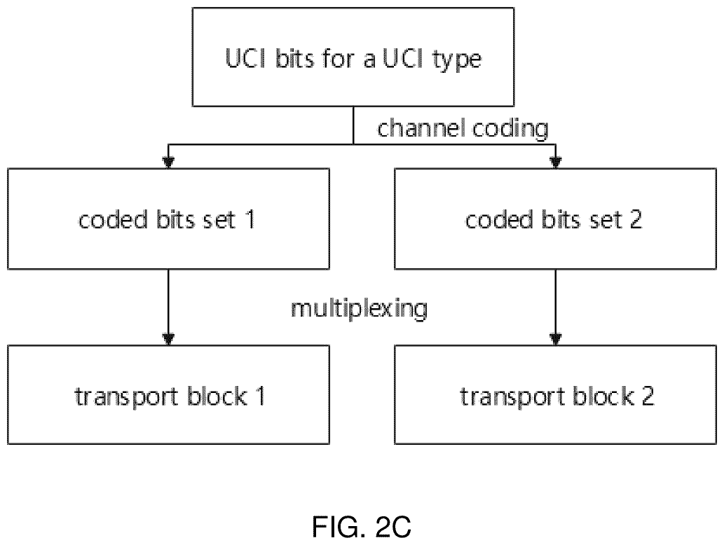

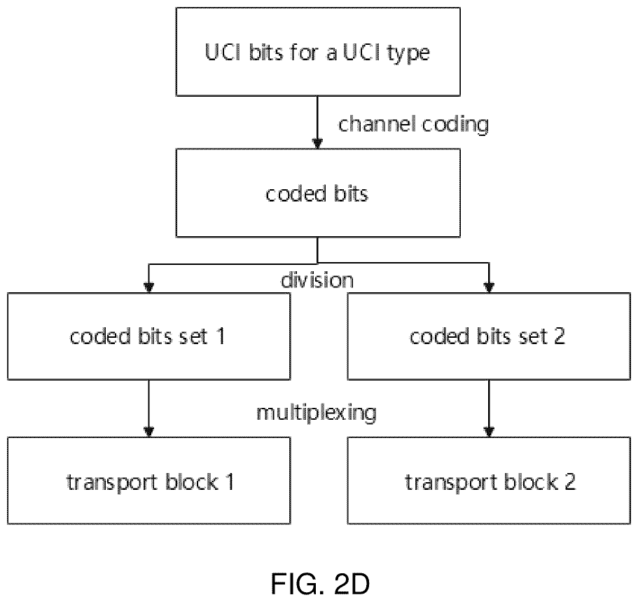

In some embodiments, control information (e.g., UCI bits) arrives at the coding unit in the form of different UCI types, and control information of a UCI type is divided into two sets. Two sets of coded bits for a UCI type are generated after channel coding based on the two sets of control information, and each of the two sets of coded bits are to be multiplexed with coded bits for the respective UL-SCH transport block as shown in FIG. 2A.

In some embodiments, control information arrives at the coding unit in the form of different UCI types, and one set of coded bits for a UCI type are generated based on the control information. The coded bits for a UCI type are to be multiplexed with coded bits for both UL-SCH transport blocks respectively as shown in FIG. 2B. The coded bits multiplexed on a first transport block and a second transport block can be the same.

In some embodiments, control information arrives at the coding unit in the form of different UCI types, and two sets of coded bits for a UCI type are generated respectively for two transport blocks based on the control information. Each of the two sets of coded bits for UCI are to be multiplexed with coded bits for the respective UL-SCH transport block as shown in FIG. 2C.

In some embodiments, control information arrives at the coding unit in the form of different UCI types, and one set of coded bits for a UCI type are generated based on the control information. The coded bits for a UCI type are divided into two sets, and the two sets of coded bits for a UCI type are multiplexed with coded bits for the first and second UL-SCH transport block respectively as shown in FIG. 2D.

### B. Data and Control Multiplexing for One of the Transport Blocks

In some embodiments, control information (e.g., UCI bits) arrives at the coding unit in the form of different UCI types, and coded bits for a UCI type are generated after channel coding based on the control information. The coded bits for a UCI type are to be multiplexed with coded bits for one of the UL-SCH transport blocks.

In some embodiments, the one of the transport blocks multiplexed with UCI is the first transport block of the PUSCH, the second transport block of the PUSCH or the transport block corresponding to the highest modulation and coding scheme value.

In some embodiments, in case the two transport blocks have the same modulation and coding scheme value, UCI is multiplexed on the first transport block.

### III. (b) (2) Example Aspect 2

In case control information is multiplexed onto PUSCH without UL-SCH, UE determines the channel coding of control information and the transmission of coded bits for control information on the one or more transport blocks of the PUSCH.

In some embodiments, control information (e.g., UCI bits) arrives at the coding unit in the form of different UCI types, and control information of a UCI type is divided into two sets. Two sets of coded bits for a UCI type are generated after channel coding based on the two sets of control information. The first set of coded bits for a UCI type are transmitted on the layers onto which the first codeword/transport block is mapped, and the second set of coded bits for a UCI type are transmitted on the layers onto which the second codeword/transport block is mapped.

In some embodiments, control information arrives at the coding unit in the form of different UCI types, and one set of coded bits for a UCI type is generated based on the control information. The set of coded bits for a UCI type is transmitted on the layers of the first and second transport block of the PUSCH. The coded bits transmitted on a first transport block and a second transport block can be the same.

In some embodiments, control information arrives at the coding unit in the form of different UCI types, and two sets of coded bits for a UCI type are generated respectively for two transport blocks based on the control information. The first and second set of coded bits for UCI are to be transmitted on the layers onto which the first and second transport block is mapped.

In some embodiments, control information arrives at the coding unit in the form of different UCI types, and one set of coded bits for a UCI type is generated based on the control information. The coded bits for a UCI type are divided into two sets. The first set of coded bits for a UCI type is transmitted on the layers onto which the first codeword is mapped, and the second set of coded bits for a UCI type is mapped on the layers onto which the second codeword is mapped.

In some embodiments, control information arrives at the coding unit in the form of different UCI types, and one set of coded bits for a UCI type is generated. The coded bits for a UCI type is transmitted on the layers onto which one of the codewords/transport blocks is mapped.

### III. (b) (3) Example Aspect 3

In some embodiments, control information of a UCI type is multiplexed as stated in at least one of the embodiments in Example Aspect 1 or 2 according to the corresponding UCI type.
In an example, for HARQ-ACK information, SR or CSI part 1, a set of coded bits for a UCI type are generated. The set of coded bits for the UCI type is multiplexed on both UL-SCH transport blocks or all layers of the PUSCH without UL-SCH.
In an example, for HARQ-ACK information, SR or CSI part 1, two sets of coded bits for a UCI type are generated based on the uplink control information bits. The two sets of coded bits for a UCI type can be the same. The first and second set of coded bits for the UCI type are multiplexed on the first and second UL-SCH transport blocks or layers onto which the first and second codeword is mapped.
In an example, for CSI part 1 or CSI part 2, two sets of coded bits for a UCI type are generated based on the first and second part of the uplink control information. The first set of coded bits for the UCI type is multiplexed on the first UL-SCH transport block or on the layers onto which the first codeword is mapped, and the second set of coded bits for the UCI type is multiplexed on the second UL-SCH transport block or on the layers onto which the second codeword is mapped.
In an example, for CSI part 1 or CSI part 2, two sets of coded bits for a UCI type are generated based on dividing the coded bits for the UCI type into two parts. The first set of coded bits for the UCI type is multiplexed on the first UL-SCH transport block or on the layers onto which the first codeword is mapped, and the second set of coded bits for the UCI type is multiplexed on the second UL-SCH transport block or on the layers onto which the second codeword is mapped.
In an example, for CSI part 1 or CSI part 2, one set of coded bits for a UCI type are generated. The set of coded bits for the UCI type is multiplexed on one of the UL-SCH transport blocks or on the layers onto which the one of the codewords/transport blocks is mapped.

In some embodiments, control information of a UCI type is multiplexed as stated in at least one of the embodiments in Example Aspect 1 or 2 according to the size of bits for the control information or the size of the coded bits for the control information.
In an example, if the size of control information of a UCI type is less than a predefined value, one set of coded bits for the UCI type is generated. The set of coded bits for the UCI type is multiplexed on both UL-SCH transport blocks or all layers of the PUSCH without UL-SCH. The coded bits multiplexed on a first transport block and a second transport block can be the same.
In an example, if the size of the coded bits for the control information of a UCI type is less than a predefined value, the set of coded bits for the UCI type is multiplexed on both UL-SCH transport blocks or all layers of the PUSCH without UL-SCH. The coded bits multiplexed on a first transport block and a second transport block can be the same.
In an example, if the size of the control information of a UCI type is less than a predefined value, two sets of coded bits for the UCI type are generated based on the control information. The first and second set of coded bits for the UCI type are multiplexed on the first and second UL-SCH transport block or on the layers onto which the first and second codeword is mapped.
In an example, if the size of control information of a UCI type is larger than a predefined value, two sets of coded bits for the UCI type are generated based on two sets of control information divided from the control information of the UCI type. The first set of coded bits for the UCI type are multiplexed on the first UL-SCH transport block or on the layers onto which the first codeword is mapped, and the second set of coded bits for the UCI type is multiplexed on the second UL-SCH transport block or on the layers onto which the second codeword is mapped.
In an example, if the size of coded bits for the control information of a UCI type is larger than a predefined value, the coded bits for the UCI type are divided into two sets. The first set of coded bits for the UCI type is multiplexed on the first UL-SCH transport block or on the layers onto which the first codeword is mapped, and the second set of coded bits for the UCI type is multiplexed on the second UL-SCH transport block or on the layers onto which the second codeword is mapped.
In an example, if the size of coded bits for the control information of a UCI type or the size of control information of a UCI type is larger or less than a predefined value, the one set of coded bits for the UCI type is multiplexed on one of the UL-SCH transport blocks or on the layers onto which one of the codewords/transport blocks is mapped.

In some embodiments, control information of a UCI type is multiplexed as stated in at least one of the embodiments in Example Aspect 1 or 2 according to whether data information, e.g., UL-SCH, is present in the PUSCH.
In an example, if UL-SCH is transmitted in the PUSCH, control information of a UCI type is multiplexed on one of the UL-SCH transport blocks, otherwise, control information of a UCI type is multiplexed on the layers onto which both codewords are mapped.
In an example, if UL-SCH is transmitted in the PUSCH, control information of a UCI type is multiplexed on two UL-SCH transport blocks by dividing the control information into two parts, otherwise, the same control information is multiplexed on the layers onto which the first and second codeword is mapped.

### III. (b) (4) Example Aspect 4

UE determines multiplexing of the coded bits for UL-SCH and uplink control information and obtaining the coded bits for multiplexed data and control information or determines the coded bits for uplink control information to be transmitted on the transport blocks of PUSCH.

In some embodiments, the output sequence of channel coding of the UCI for each of transport blocks is obtained by replicating the UCI bits multiplexed on the corresponding transport block NL times, where NL is the number of layers onto which the corresponding UL-SCH transport block is mapped.

In some embodiments, the output sequence of channel coding of the UCI for each of the transport blocks is obtained based on at least one of: interleaving, polar encoding or a coding scheme based on a predefined table/rule for the UCI bits multiplexed on the corresponding transport block.

In some embodiments, the output sequence of channel coding of the UCI bits multiplexed on the PUSCH is divided into two sets, and the first and second set of coded bits for UCI are transmitted on the first and second transport block respectively.

### III. (c) Example Embodiment 3

Embodiment 3 describes techniques to determine the number of coded modulation symbols for uplink control information in a layer (or a transmission layer) of the PUSCH transmission with up to two transport blocks in case uplink control information is multiplexed on the PUSCH.

Coded modulation symbols for uplink control information are obtained based on the coded bits for uplink control information and the modulation order. The coded modulation symbols for uplink control information are mapped on the resource elements in the order of per UCI type, per hopping is configured, per OFDM symbol, per resource element. per layer (e.g., the coded modulation symbols for UCI are mapped on the same RE index of all layers of a transport block, and then the next RE index.).

In some embodiments, the number of coded modulation symbols for uplink control information in each layer of the two transport blocks is the same.

In some embodiments, the number of coded modulation symbols for uplink control information in each layer of the first transport block is the same, and the number of coded modulation symbols for uplink control information in each layer of the second transport block is the same.

In some embodiments, the number of coded modulation symbols for uplink control information in a layer is determined based on at least one of: a scaling factor, the total number of resource elements/subcarriers that can be used for transmission of UCI in all OFDM symbols of the PUSCH, the total number of resource elements/subcarriers that can be used for transmission of UCI in specific OFDM symbols of the PUSCH, the number of coded modulation symbols in a layer for UCI with a different type, the number of UCI bits, the number of CRC bits for the UCI, an offset value, the sum of code block size for one or two UL-SCH of the PUSCH transmission, the code rate of the one or both transport blocks of the PUSCH or the modulation order of the one or both transport blocks of the PUSCH.

In an example, the number of coded modulation symbols for UCI transmission in a layer is determined to be the minimum number of: (1) a value determined based on a scaling factor and the total number of resource elements/subcarriers that can be used for transmission of UCI in all or specific OFDM symbols; (2) the number of coded modulation symbols for UCI with a different type in the layer; (3) a value determined based on the number of UCI bits, the number of CRC bits for the UCI, an offset value, the sum of code block size for a UL-SCH transport block of the PUSCH transmission and the total number of resource elements/subcarriers that can be used for transmission of UCI in all OFDM symbols of a transport block.

$${Q}_{UCI}^{′} = min \{ ⌈ \frac{( {O}_{UCI} + {L}_{UCI} ) \cdot {β}_{offset}^{PUSCH} \cdot {\sum }_{l = 0}^{{N}_{symb , all}^{PUSCH , i} - 1} {M}_{s c}^{UCI , i} ( l )}{{\sum }_{r = 0}^{{C}_{UL - SCH}^{( i )} - 1} {K}_{r}^{( i )}} ⌉ , ⌈ α \cdot {\sum }_{l = {l}_{0}}^{{N}_{symb , all}^{PUSCH} - 1} {M}_{s c}^{UCI} ( l ) ⌉ - {Q}_{UCI \_ 0}^{′} \}$$

where O_{UCI} is the number of bits for the UCI; L_{UCI} is the number of CRC bits for the corresponding type of UCI; β_{offset}^{PUSCH} is the offset value indicated by the DCI or configured by RRC signalling for the corresponding UCI;

$${\sum }_{l = 0}^{{N}_{symb , all}^{PUSCH , i} - 1} {M}_{s c}^{UCI , i} ( l )$$

is the total number of resource elements/subcarriers that can be used for transmission of UCI in all OFDM symbols of i-th transport block;

$${\sum }_{r = 0}^{{C}_{UL - SCH}^{( i )} - 1} {K}_{r}^{( i )}$$

is the total code block size for the i-th UL-SCH transport block. The variable “i” represents the transport block index corresponding to the transport block onto which the UCI is multiplexed. α is the scaling factor;

$${\sum }_{l = {l}_{0}}^{{N}_{symb , all}^{PUSCH} - 1} {M}_{s c}^{UCI} ( l )$$

is the total number of resource elements/subcarriers that can be used for transmission of UCI in OFDM symbols starting from index l₀; Q′_{UCI_0} is the number of coded modulation symbols for UCI different from the current UCI type.

In an example, the number of coded modulation symbols for UCI transmission in a layer is determined to be the minimum number of: (1) a value determined based on a scaling factor and the total number of resource elements/subcarriers that can be used for transmission of UCI in all or specific OFDM symbols; (2) the number of coded modulation symbols for UCI with a different type in the layer; (3) a value determined based on the number of UCI bits, the number of CRC bits for the UCI, an offset value, the sum of code block size for each of the two UL-SCH transport blocks of the PUSCH transmission, and the total number of resource elements/subcarriers that can be used for transmission of UCI in all OFDM symbols of each of the two transport blocks.

$${Q}_{UCI}^{′} = min \{ ⌈ \frac{( {O}_{UCI} + {L}_{UCI} ) \cdot {β}_{offset}^{PUSCH} \cdot {\sum }_{l = 0}^{{N}_{symb , all}^{PUSCH , 1} - 1} {M}_{s c}^{UCI , 1} ( l ) \cdot {\sum }_{l = 0}^{{N}_{symb , all}^{PUSCH , 2} - 1} {M}_{s c}^{UCI , 1} ( l )}{{\sum }_{r = 0}^{{C}_{UL - SCH}^{( 1 )} - 1} {K}_{r}^{( 1 )} \cdot {\sum }_{l = 0}^{{N}_{symb , all}^{PUSCH , 2} - 1} {M}_{s c}^{UCI , 2} ( l ) + {\sum }_{r = 0}^{{C}_{UL - SCH}^{( 2 )} - 1} {K}_{r}^{( 2 )} \cdot {\sum }_{l = 0}^{{N}_{symb , all}^{PUSCH , 1} - 1} {M}_{s c}^{UCI , 1} ( l )} ⌉ , ⌈ α \cdot {\sum }_{l = {l}_{0}}^{{N}_{symb , all}^{PUSCH} - 1} {M}_{s c}^{UCI} ( l ) ⌉ - {Q}_{UCI \_ 0}^{′}$$

where O_{UCI} is the number of bits for the UCI; L_{UCI} is the number of CRC bits for the corresponding type of UCI; β_{offset}^{PUSCH} the offset value indicated by the DCI or configured by RRC signalling for the corresponding UCI;

$${\sum }_{l = 0}^{{N}_{symbol , all}^{PUSCH , 1} - 1} {M}_{s c}^{UCI , 1} ( l ) and {\sum }_{l = 0}^{{N}_{symbol , all}^{PUSCH , 2} - 1} {M}_{s c}^{UCI , 2} ( l )$$

are the total number of resource elements/subcarriers that can be used for transmission of UCI in all OFDM symbols of the first and second transport block;

$${\sum }_{r = 0}^{{C}_{UL - SCH}^{( 1 )} - 1} {K}_{r}^{( 1 )} and {\sum }_{r = 0}^{{C}_{UL - SCH}^{( 2 )} - 1} {K}_{r}^{( 2 )}$$

are the total code block size for the first and second UL-SCH transport block. α is the scaling factor;

$${\sum }_{l = {l}_{0}}^{{N}_{symbol , all}^{PUSCH} - 1} {M}_{s c}^{UCI} ( l )$$

is the total number of resource elements/subcarriers that can be used for transmission of UCI in OFDM symbols starting from index l₀; Q′_{UCI_0} is the number of coded modulation symbols for UCI different from the current UCI type.

In an example, UCI is multiplexed on the PUSCH without UL-SCH, the number of coded modulation symbols for UCI transmission in a layer is determined to be the minimum number of: (1) a value determined based on a scaling factor and the total number of resource elements/subcarriers that can be used for transmission of UCI in all or specific OFDM symbols; (2) the number of coded modulation symbols for UCI with a different type in the layer; (3) a value determined based on the number of UCI bits, the number of CRC bits for the UCI, an offset value, the code rate of a transport block of the PUSCH and the modulation order of a transport block of the PUSCH.

$${Q}_{UCI}^{′} = min \{ ⌈ \frac{( {O}_{UCI} + {L}_{UCI} ) \cdot {β}_{offset}^{PUSCH}}{{R}^{( i )} \cdot {Q}_{m}^{( i )}} ⌉ , ⌈ α \cdot {\sum }_{l = {l}_{0}}^{{N}_{symb , all}^{PUSCH} - 1} {M}_{s c}^{UCI} ( l ) ⌉ - {Q}_{UCI \_ 0}^{′} \}$$

where O_{UCI} is the number of bits for the UCI; L_{UCI} is the number of CRC bits for the corresponding type of UCI; β_{offset}^{PUSCH} is the offset value indicated by the DCI or configured by RRC signalling for the corresponding UCI; R⁽ⁱ⁾ is the code rate of the i-th transport block of the PUSCH; Qₘ⁽ⁱ⁾ is the modulation order of the i-th transport block of the PUSCH. The variable “i” represents the transport block index corresponding to the transport block onto which the UCI is multiplexed. α is the scaling factor;

$${\sum }_{l = {l}_{0}}^{{N}_{symb , all}^{PUSCH} - 1} {M}_{s c}^{UCI} ( l )$$

is the total number of resource elements/subcarriers that can be used for transmission of UCI in OFDM symbols starting from index l₀; Q′_{UCI_0} is the number of coded modulation symbols for UCI different from the current UCI type.

In an example, UCI is multiplexed on the PUSCH without UL-SCH, the number of coded modulation symbols for UCI transmission in a layer is determined to be the minimum number of: (1) a value determined based on a scaling factor and the total number of resource elements/subcarriers that can be used for transmission of UCI in all or specific OFDM symbols; (2) the number of coded modulation symbols for UCI with a different type in the layer; (3) a value determined based on the number of UCI bits, the number of CRC bits for the UCI, an offset value, the code rate of each of the two transport blocks of the PUSCH and the modulation order of each of the two transport blocks of the PUSCH.

$${Q}_{UCI}^{′} = min \{ ⌈ \frac{( {O}_{UCI} + {L}_{UCI} ) \cdot {β}_{offset}^{PUSCH}}{{R}^{( 1 )} \cdot {Q}_{m}^{( 1 )} + {R}^{( 2 )} \cdot {Q}_{m}^{( 2 )}} ⌉ , ⌈ α \cdot {\sum }_{l = {l}_{0}}^{{N}_{symb , all}^{PUSCH} - 1} {M}_{s c}^{UCI} ( l ) ⌉ - {Q}_{UCI \_ 0}^{′} \}$$

where O_{UCI} is the number of bits for the UCI; L_{UCI} is the number of CRC bits for the corresponding type of UCI; β_{offset}^{PUSCH} is the offset value indicated by the DCI or configured by RRC signalling for the corresponding UCI; R⁽¹⁾ and R⁽²⁾ are the code rate of the first and second transport block of the PUSCH; Qₘ⁽¹⁾ and Qₘ⁽²⁾ are the modulation order of the first and second transport block of the PUSCH. α is the scaling factor;

$${\sum }_{l = {l}_{0}}^{{N}_{symb , all}^{PUSCH} - 1} {M}_{s c}^{UCI} ( l )$$

is the total number of resource elements/subcarriers that can be used for transmission of UCI in OFDM symbols starting from index l₀; Q′_{UCI_0} is the number of coded modulation symbols for UCI different from the current UCI type.

In some embodiments, Q′_{UCI_0} is zero in case no UCI different from the current UCI type is multiplexed on the PUSCH.

In embodiments and examples above, the number of UCI bits can be the number of bits for uplink control information or the number of coded bits for uplink control information multiplexed on the PUSCH or on a transport block of the PUSCH or on a layer of the PUSCH.

In embodiments and example above, the specific OFDM symbols that can be used for transmission of UCI or the variable ‘l₀’ is determined based on the symbol index of the first OFDM symbol that does not carry DMRS of the PUSCH, after the first DMRS symbol(s), in the PUSCH transmission.

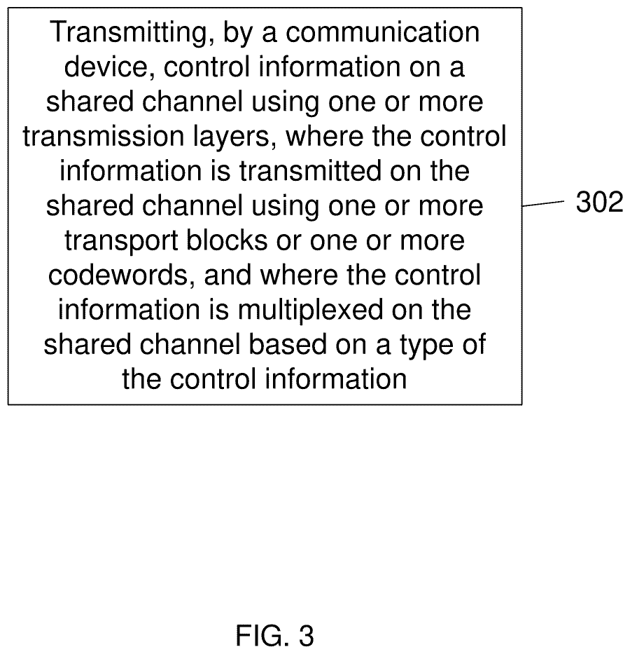

FIG. 3 shows an exemplary flowchart for transmitting control information. Operation 302 includes transmitting, by a communication device, control information on a shared channel using one or more transmission layers, where the control information is transmitted on the shared channel using one or more transport blocks or one or more codewords, and where the control information is multiplexed on the shared channel based on a type of the control information.

In some embodiments, a number of transport blocks or a number of codewords is based on at least one of: a total number of the one or more transmission layers, or a first message received from a network device. In some embodiments, the first message indicates to enable or allow an uplink transmission with more than one codeword or more than one transport block. In some embodiments, the first message indicates a maximum number of codewords or a maximum number of transport blocks for an uplink transmission is one or more. In some embodiments, an uplink transmission is associated with the shared channel.

In some embodiments, a payload of an indication field for a second transport block is zero in a downlink control information (DCI) corresponding to an uplink transmission in response to: determining an absence of a reception of a first message, receiving the first message that indicates that an uplink transmission with two codewords is disabled, or a configured maximum number of transmission layers or rank of the uplink transmission being not greater than a specific value. In some embodiments, the control information is multiplexed on one transport block or on two transport blocks for all types of the control information. In some embodiments, the control information is multiplexed on one transport block or on two transport blocks based on the type of the control information. In some embodiments, the control information is multiplexed on one or two transport blocks based on a bit size of the control information or a bit size of coded bits for the control information.

In some embodiments, the control information is multiplexed on the shared channel by determining one or two sets of coded bits for control information to be transmitted on the shared channel, wherein the one or two sets of coded bits are determined according to any one of: generating one set of coded bits for the control information based on bits of the control information; or dividing bits of the control information into two parts, and generating two sets of coded bits corresponding to the two parts; or generating one set of coded bits for the control information based on the bits of the control information, and dividing the one set of coded bits for the control information into two sets; or generating one set of coded bits for the control information based on the bits of the control information, and obtaining two sets of coded bits by replicating the one set of coded bits; or generating a first set of coded bits for the control information based on the bits of the control information, and generating a second set of coded bits for the information based on the bits of the control information. In some embodiments, the determining of the one or two sets of coded bits for control information is based on the type of the control information, a bit size of the control information, or a bit size of the coded bits of the control information.

In some embodiments, the control information is multiplexed on the shared channel according to the following: a first set of coded bits for the control information and a second set of coded bits for the control information is multiplexed with coded bits for a first uplink shared channel (UL-SCH) transport block and a second UL-SCH transport block, respectively. In some embodiments, the control information is multiplexed on the shared channel according to the following: a first set of coded bits for the control information and a second set of coded bits for the control information are transmitted on a first transport block and a second transport block of a physical uplink shared channel (PUSCH) in response to an uplink shared channel (UL-SCH) being not present in the PUSCH. In some embodiments, the control information is multiplexed on the shared channel by determining a number of coded modulation symbols for the control information in a transmission layer of a transport block onto which the control information is multiplexed.

In some embodiments, the number of coded modulation symbols is determined to be one of the following or a minimum number of more than one of the following: a value based on a scaling factor, and a total number of resource elements or a total number of subcarriers to be used for the transmitting the control information in all or specific orthogonal frequency division multiplex (OFDM) symbols; a number of coded modulation symbols for the control information with a different type in the transmission layer; a value based on a number of bits of the control information, a number of a cyclic redundancy check (CRC) bits for the control information, an offset value, a sum of code block size for a corresponding or both uplink shared channel (UL-SCH) transport block of the shared channel transmission and a total number of resource elements or a total number of subcarriers to be used for the transmitting the control information in all OFDM symbols of a corresponding transport block or both transport blocks; a value based on the number of bits of the control information, the number of CRC bits for the control information, the offset value, a code rate of each of two transport blocks of the shared channel and a modulation order of each of the two transport blocks of the shared channel; or a value based on the number of bits of the control information, the number of CRC bits for the control information, the offset value, the code rate of the corresponding transport block of the shared channel and the modulation order of the corresponding transport block of the shared channel.

In some embodiments, the control information includes hybrid automatic repeat request acknowledgement (HARQ-ACK) information, scheduling request (SR), link recovery request (LRR), channel state information (CSI) part 1, or CSI part 2. In some embodiments, the control information includes uplink control information (UCI), and wherein the shared channel includes a physical uplink shared channel (PUSCH).

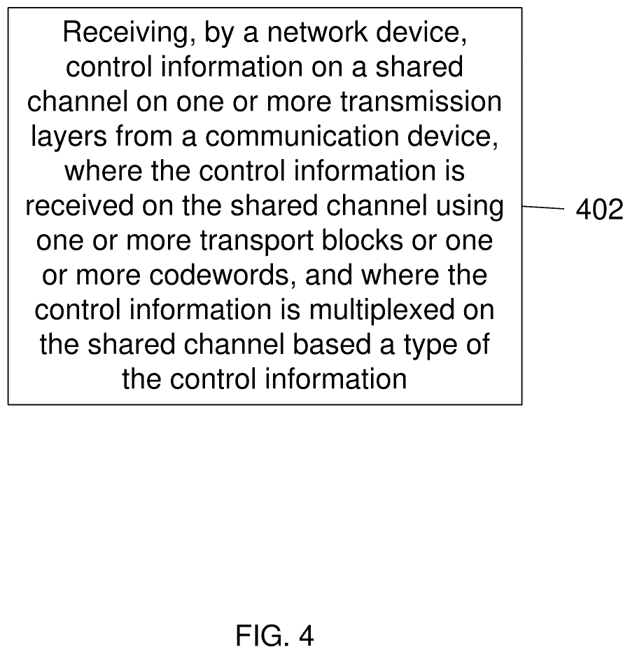

FIG. 4 shows an exemplary flowchart for receiving control information. Operation 402 includes receiving, by a network device, control information on a shared channel on one or more transmission layers from a communication device, where the control information is received on the shared channel using one or more transport blocks or one or more codewords, and where the control information is multiplexed on the shared channel based a type of the control information.

In some embodiments, a number of transport blocks or a number of codewords is based on at least one of: a total number of the one or more transmission layers, or a first message transmitted by the network device. In some embodiments, the first message indicates to enable or allow an uplink transmission with more than one codeword or more than one transport block, or the first message indicates a maximum number of codewords or a maximum number of transport blocks for an uplink transmission is one or more. In some embodiments, an uplink transmission is associated with the shared channel.

In some embodiments, a payload of an indication field for a second transport block is zero in a downlink control information (DCI) corresponding to an uplink transmission in response to: an absence of a transmission of a first message, transmitting the first message that indicates that the uplink transmission with two codewords is disabled, or a configured maximum number of transmission layers or rank of the uplink transmission being not greater than a specific value. In some embodiments, the control information is multiplexed on one transport block or on two transport blocks for all types of the control information, or where the control information is multiplexed on one transport block or on two transport blocks based on the type of the control information, or where the control information is multiplexed on one or two transport blocks based on a bit size of the control information or a bit size of coded bits for the control information.

In some embodiments, a payload of an indication field in a downlink control information (DCI) for a second transport block in a DCI format is determined by a predefined table and/or a maximum number of schedulable shared channel in response to: a transmission of a first message that indicates to allow or enable an uplink transmission with more than one codeword or more than one transport block, or a maximum number of transmission layers or rank for the uplink transmission is configured to be larger than a specific value. In some embodiments, the control information includes hybrid automatic repeat request acknowledgement (HARQ-ACK) information, scheduling request (SR), link recovery request (LRR), channel state information (CSI) part 1, or CSI part 2. In some embodiments, the control information includes uplink control information (UCI), and wherein the shared channel includes a physical uplink shared channel (PUSCH).

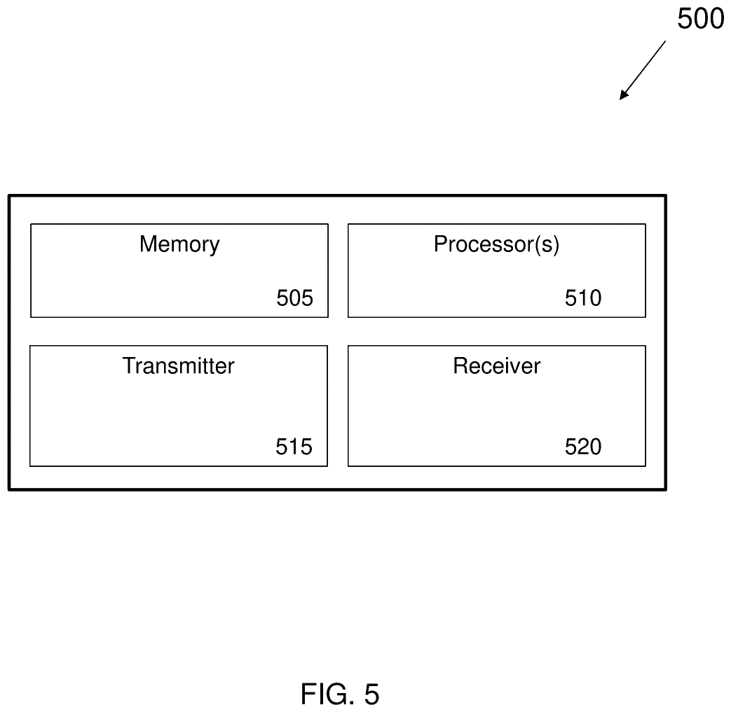

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

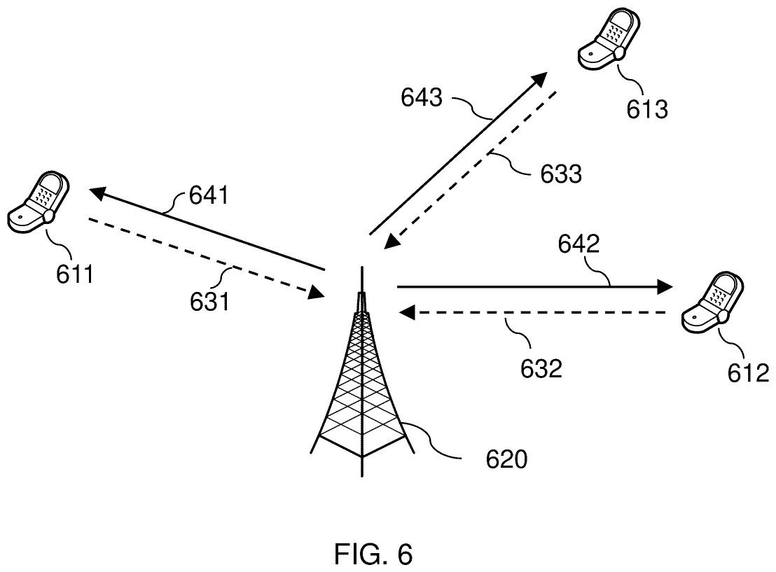

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
transmitting, by a communication device, control information on a shared channel using one or more transmission layers,
wherein the control information is transmitted on the shared channel using one or more transport blocks or one or more codewords,
wherein the control information is multiplexed on the shared channel based on a type of the control information,
wherein a number of transport blocks or a number of codewords is based on at least one of: a total number of the one or more transmission layers, or a first message received from a network device, and
wherein an uplink transmission is associated with the shared channel.

2. The method of claim 1, wherein a payload of an indication field for a second transport block is zero in a downlink control information (DCI) corresponding to an uplink transmission in response to determining an absence of a reception of a first message, a configured maximum number of transmission layers or rank of the uplink transmission being not greater than a specific value.

3. The method of claim 1, wherein the control information is multiplexed on one transport block for all types of the control information.

4. The method of claim 1, wherein the control information is multiplexed on the shared channel by determining one set of coded bits for control information to be transmitted on the shared channel, wherein the one set of coded bits are determined based on bits of the control information.

5. The method of claim 1, wherein the control information is multiplexed on the shared channel by determining a number of coded modulation symbols for the control information in a transmission layer of a transport block onto which the control information is multiplexed.

6. The method of claim 5,
wherein the number of coded modulation symbols is determined to be one of the following or a minimum number of more than one of the following:
a value based on a scaling factor, and a total number of resource elements or a total number of subcarriers to be used for the transmitting the control information in all or specific orthogonal frequency division multiplex (OFDM) symbols;
a number of coded modulation symbols for the control information with a different type in the transmission layer;
a value based on a number of bits of the control information, a number of a cyclic redundancy check (CRC) bits for the control information, an offset value, a sum of code block size for a corresponding or both uplink shared channel (UL-SCH) transport block of the shared channel transmission and a total number of resource elements or a total number of subcarriers to be used for the transmitting the control information in all OFDM symbols of a corresponding transport block or both transport blocks;
a value based on the number of bits of the control information, the number of CRC bits for the control information, the offset value, a code rate of each of two transport blocks of the shared channel and a modulation order of each of the two transport blocks of the shared channel; or
a value based on the number of bits of the control information, the number of CRC bits for the control information, the offset value, the code rate of the corresponding transport block of the shared channel and the modulation order of the corresponding transport block of the shared channel.

7. The method of claim 1,
wherein the control information includes hybrid automatic repeat request acknowledgement (HARQ-ACK) information, scheduling request (SR), link recovery request (LRR), channel state information (CSI) part 1, or CSI part 2, and
wherein the control information includes uplink control information (UCI), and wherein the shared channel includes a physical uplink shared channel (PUSCH).

8. The method of claim 1, wherein each codeword is mapped to a corresponding transport block.

9. The method of claim 1, wherein the first message indicates that the transmitting or the receiving of the control information on the shared channel is with more than four transmission layers.

10. The method of claim 1, further comprising:
receiving, by the communication device, a message indicative of disabling uplink transmission with two codewords, wherein the communication device determines a mapping of a codeword to a transmission layer based on a codeword-to-layer mapping rule for the number of codeword being equal to 1.

11. The method of claim 3,
wherein the one transport block for multiplexing the control information has a highest modulation and coding scheme value from among a plurality of transport blocks
wherein the one transport block is from two transport blocks, and
wherein the one transport block for multiplexing the control information is a first transport block in response to the two transport blocks having same modulation and coding scheme value.

12. A wireless communication method, comprising:
receiving, by a network device, control information on a shared channel on one or more transmission layers from a communication device,
wherein the control information is received on the shared channel using one or more transport blocks or one or more codewords,
wherein the control information is multiplexed on the shared channel based a type of the control information,
wherein a number of transport blocks or a number of codewords is based on at least one of: a total number of the one or more transmission layers, or a first message transmitted by the network device, and
wherein an uplink transmission is associated with the shared channel.

13. The method of claim 12, wherein a payload of an indication field for a second transport block is zero in a downlink control information (DCI) corresponding to an uplink transmission in response to an absence of a transmission of a first message, a configured maximum number of transmission layers or rank of the uplink transmission being not greater than a specific value.

14. The method of claim 12,
wherein the control information is multiplexed on one transport block for all types of the control information,
wherein the control information includes hybrid automatic repeat request acknowledgement (HARQ-ACK) information, scheduling request (SR), link recovery request (LRR), channel state information (CSI) part 1, or CSI part 2, and
wherein the control information includes uplink control information (UCI), and wherein the shared channel includes a physical uplink shared channel (PUSCH).

15. The method of claim 12, wherein each codeword is mapped to a corresponding transport block.

16. The method of claim 12, wherein the first message indicates that the transmitting or the receiving of the control information on the shared channel is with more than four transmission layers.

17. A communication device for wireless communication comprising one or more processors, configured to cause the communication device to:
transmit control information on a shared channel using one or more transmission layers,
wherein the control information is transmitted on the shared channel using one or more transport blocks or one or more codewords,
wherein the control information is multiplexed on the shared channel based on a type of the control information,
wherein a number of transport blocks or a number of codewords is based on at least one of: a total number of the one or more transmission layers, or
a first message received from a network device, and
wherein an uplink transmission is associated with the shared channel.

18. The communication device of claim 1, wherein a payload of an indication field for a second transport block is zero in a downlink control information (DCI) corresponding to an uplink transmission in response to a determination of an absence of a reception of a first message, a configured maximum number of transmission layers or rank of the uplink transmission being not greater than a specific value.

19. A network device for wireless communication comprising one or more processors, configured to cause the network device to:
receive control information on a shared channel on one or more transmission layers from a communication device,
wherein the control information is received on the shared channel using one or more transport blocks or one or more codewords,
wherein the control information is multiplexed on the shared channel based a type of the control information,
wherein a number of transport blocks or a number of codewords is based on at least one of: a total number of the one or more transmission layers, or
a first message transmitted by the network device, and
wherein an uplink transmission is associated with the shared channel.

20. The network device of claim 19,
wherein a payload of an indication field for a second transport block is zero in a downlink control information (DCI) corresponding to an uplink transmission in response to an absence of a transmission of a first message, a configured maximum number of transmission layers or rank of the uplink transmission being not greater than a specific value.
